(19) United States
(12) Patent Application Publication
(10) Pub. No.: US 2003/0101098 A1
(43) Pub. Date: May 29, 2003

(54) Process and device for managing automatic data flow between data processing units for operational order processing

(76) Inventor: Erich Schaarschmidt, Niederviehbach (DE)

Correspondence Address: Rocco S. Barrese, Esq., DILWORTH & BARRESE, LLP, 333 Earle Ovington Blvd., Uniondale, NY, 11553, US

(21) Appl. No.: 09/995,119

(22) Filed: Nov. 27, 2001

(51) Int. Cl. G06F 17/60

(52) U.S. Cl. 705/26

(57) ABSTRACT

This invention relates to a process and a device for managing automatic data flows between data processing units for order processing, particularly relating to a variant product, that comprises at least one CAD system for product design, one ERP system for resource planning for order processing, and one order preparation device for preparation of the current order, preferably with a display module for preparation of the order to be processed. According to the invention, a central control unit is provided that holds a set of product variables ready for the current variant product, and assigns the values retrieved by the order preparation unit for the product variables to the set of product variables, in order to produce a set of specific product parameters that also automatically generates a set of ERP parameters required by the ERP system for processing the order, and a set of CAD parameters that the CAD system requires for processing the order, in a data format compatible with the CAD system and/or the ERP system and forwards the same to the CAD system and the ERP system. According to the invention, the data retrieved from the various data processing units for processing of an order are compiled in the central control unit into a central set of variables and are filled in by means of retrieval from the order preparation unit. Such variable set with values is further divided into separate ERP data and CAD data that are then processed in the ERP system or the CAD system.

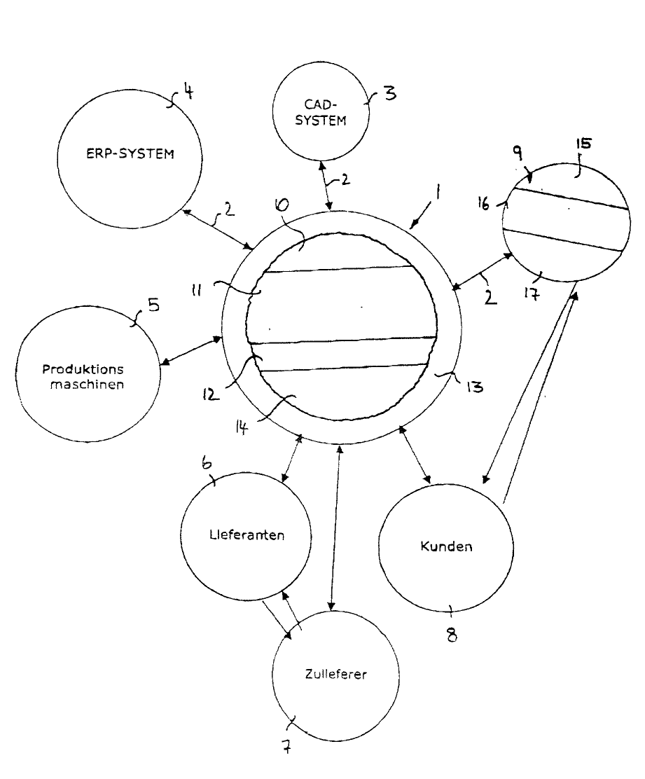

This invention relates to a process and a device for managing automatic data flow between data processing units for order processing, particularly for a variant product, that comprises at least one ERP system for resource planning for order processing, and one order preparation unit for preparation of the current order.

Various software and data processing units generally participate in the handling of customer orders from placement of the order to billing. For example, first the product to be manufactured is established by means of an input terminal, i.e., the individual parameters of the product ordered are established. Then, based on previously-determined product specifications, the product is designed on a CAD system and a design drawing is produced. Production planning is then undertaken on an ERP system (an “Enterprise Resource Planning System”) to carry out company-wide resource planning with regard to production, finance, distribution and plant organization. The production is generally handled by an electronic production order planning system that selects, controls and supplies materials to the production equipment required. Furthermore, machine programs for controlling the production equipment or facilities must be fed the corresponding parameters for controlling the equipment. Delivery and accounting, including bookkeeping, etc., has recently been turned over to the corresponding software modules. The problem here is that the software structure of a company is generally a colorful palette made up of a variety of software products. The individual software modules or data processing units are generally not compatible with each other so that networking is generally impossible. The data used in one system are unusable to the next system. Moreover, an ERP system, for example, requires client input data than a CAD system can supply so that automatic interaction among the modules is not possible even to that extent.

This invention relates to facilitating automatic data flow between data processing units involved in order processing for a specific product.

This task is solved, according to the invention, by a process and a device according to claims 1 and 4. Preferred embodiments of the invention are the subjects of Subclaims.

A central control unit is also provided that can be connected with any of the data processing units, including the ERP system and the order preparation equipment, where a set of product variables with specific product parameters is held by the central control unit, in a memory, for the variants; this memory is queried so that one set of specific product parameters is produced in the central control unit. From this set of specific product parameters, the central control unit generates a set of ERP parameters that the ERP system requires to prepare the specific order. ERP parameters generated in this manner are automatically forwarded by the central control unit to the ERP system so that the corresponding data is available there for the preparation of the special order. Depending on which additional data processing units are included in the handling of the order, the central control unit generates, from this set of specific parameters, a set of parameters that the individual data processing unit requires for preparing the specific order, in a data format compatible with the data processing unit in question, and forwards the data automatically to the appropriate data processing unit.

In particular, from the set of specific product parameters retrieved via the order preparation unit, the central control unit can also generate a set of design-relevant CAD parameters required by the CAD system to prepare the specific order. The central control unit makes them automatically available to the CAD system so that it can be in a position to prepare a design drawing for the individually-configured product. In view of the large quantity of data already in CAD systems, it proves more than very advantageous to call up only the specific product parameters and to generate the CAD parameters automatically from them, based on the CAD system prepares the drawing, particularly based on a prepared parameterized design model.

The data retrievals of the individual data processing units, i.e., the data sets required by the data processing units as well as the ERP system and the CAD system, are compiled in the central control unit into a central set of variables and returned by a query from the order preparation unit. The set of variables receiving values in such manner can then be almost reverse engineered, i.e., divided into ERP data and CAD data, etc., by the ERP system and the CAD system.

The combination of data retrievals from the individual data processing units in the central control unit requires only a one-time input of the order or the product-specific parameters. All data processing units involved in the order processing are supplied from there with the appropriate data. The central control unit then creates a virtual or cybernetic interface between the ERP system and the CAD system. The ERP and CAD data generated by the central control unit, that are forwarded automatically to the ERP system or the CAD system, are expediently generated in precisely the data format preset by the appropriate interface to the ERP system or the CAD system and are thus compatible with the system in question.

In another aspect of the invention, a reduction in variables is provided for. The set of variables held ready by the central control unit is determined based on the ERP parameters required by the ERP system and based on the CAD parameters required by the CAD system, where corresponding or dependent ERP parameters and CAD parameters are combined into a single common variable. If, for example, the ERP system requires the length of the variant product such as a ladder in order to generate a request to the plant organization, and if the CAD system also needs said product length, only one variable, “Product Length”, is held ready in the central control unit and assigned a corresponding value during product configuration. Said common variable, “Product Length”, is then re-divided into two parameters, i.e., on the one hand, into the “Product Length” ERP parameter compatible with the ERP system, and on the other, into the “Product Length” CAD parameter compatible with the CAD system. An example of the dependency of two ERP and CAD parameters is that, with a given product length, there is only one permissible color. If, for example, all ladders of more than 10 meters in length are red in color, only the product length has to be held ready as a variable in the central control module. As a function of the value contained in this variable, the central control unit then generates the dependent ERP parameter, “Color”.

Preferably, the corresponding variant logic that determined said dependency of product features is placed in a logic module in the central control unit so that it can be accessed there during generation of the data specific to the appropriate data processing unit.

In another aspect of the invention, the central control unit not only controls the data flow between the ERP system and the CAD system, but also other data processing units, such as a production control center, can also be included in particular. The central control unit preferably generates a set of production parameters from the data retrieved by the order production unit out of the data held ready by the ERP system and/or the data held ready by the CAD system and automatically forwards it to the production control center. Here, a set of variables to be assigned the data prepared by the order preparation unit, the ERP system or the CAD system can advantageously be held ready. This advantageously ensures that the production parameters are generated in a format compatible with the production control center.

In another aspect of the invention, order simulation means can be provided that generate an order simulation query to the ERP system based on the set of production parameters determined in the central control unit. As a function of the parameters forwarded by the retrieval, the ERP system generates supply data such as delivery date, price, etc., and forwards this supply data to the central control unit. The latter forwards said supply data to the order preparation unit, preferably online, so that said supply data can be communicated to the customer immediately upon order configuration.

The order preparation unit advantageously has display means for visualizing variant products. A parameterized model of the current variant product can advantageously be stored in a storage unit; the model is assigned the data on the variant product retrieved by the order preparation unit and then displayed based on the custom-tailored configured product.

The invention is explained below in greater detail based on a preferred embodiment and one related drawing. The single drawing shows, schematically, the construction of a device according to the invention as well as its cooperation with various data processing units included in the order handling related to a variant product.

The central control unit 1 can be created in the form of a software tool that runs on a computer. As the FIGURE shows, data transfer connections 2 are provided between the central control unit 1 and various data processing units involved in order handling. In particular, the central control unit 1 can be connected with a CAD system 3, an ERP system, i.e., an “Enterprise Resource Planning System”, 4, a production control center 5 that, in turn, contains or can be connected with various production machines, as well as with the data processing unit of a contractor 6, a subcontractor or supplier 7, if applicable, and a customer 8.

Furthermore, an order preparation unit 9 is provided that can be in the form of a portable computer, such as a laptop with display, as well as the display software running thereon.

The central control unit 1 controls the data flow between data processing units 3 through 9, as explained below. In relation to the example of a ladder, the following flow of functions results:

In the CAD system 3, a parameterized model of the individually configurable ladder is held ready. The dimensions are replaced in such a parameterized model with variables and the individual variables can be linked via calculation rules. For instance, the length of the ladder, the number of rungs, and the distance between rungs can be variable and thus parameterized.

In the ERP system 4, a variant logic for the ladder is constructed, i.e., various features such as color, length and feature characteristics, such as the color red, or the 1 meter length, can be defined and placed in relation to each other. For example, provision can be made such that if the length is more than 1 meter, the color is always red.

The data requests and the interrelations between the ERP system 4 and the CAD system 3 are automatically picked up in the central control unit 1.

Generally, the data sets that the data processing units 3 through 7 require to be able to process a special order are compiled in the central control unit 1 into a common, product-specific set of variables. These variables are assigned specific values centrally in the central control unit 1 upon configuration of the variant product. The common variable set is then divided again into data sets specific to data processing units and fed to the appropriate data processing unit.

This can occur in the following manner:

By means of order preparation unit 9, the product variables (in the case of the ladder, the length of the ladder, the number of rungs, the distance between rungs, the material of the ladder and the color of the ladder) are retrieved. The set of variables for the ladder product, held ready in the central control unit, is then assigned the retrieved values so that a customer-specific set of product parameters is produced. Both the set of variables and the corresponding specific product parameters set are stored in a storage unit 10 of the central control unit 1. From the customer-specific configured product parameters, the central control unit 1 generates first the CAD parameters and the ERP parameters that it transmits to the CAD system 3 and the ERP system 4. The CAD and ERP parameters here are formatted specifically to the system, so that the data are made available in forms compatible with the CAD system or the ERP system. Upon generating the CAD and ERP parameters, the central control unit 9 accesses the data linkage means 11 that links the individual variables from the stored set of variables with various CAD and ERP parameters. The data linkage means 11 has a logic module 12 for this that stores the dependencies between ERP and CAD parameters and determines the appropriate ERP and CAD parameters from the corresponding variables or customer-specific configured product parameters, using the stored dependencies. In the CAD system 3 and in the ERP system 4, CAD and ERP parameters generated in such manner are determined accordingly.

In the ERP System, a customer order can be produced and booked, while in the CAD System, a scale CAD drawing can be produced through the data supplied by the central control unit 1, based on the parameterized model of the ladder. This drawing can either by assigned directly to the customer order in the ERP system, via a document management system, and thus forwarded to other sections of the company, or it can be newly produced whenever needed through the parameterized model construction and the data stored in the central control unit. Here it is a particular advantage that only the parameters specifying the product, and not the whole drawing, have to be stored. The otherwise very large amounts of data usually required for CAD drawings are thus avoided and substantially less disk space is used.

Furthermore, the central control unit 1 controls the data flow from and to the production machinery. From the data retrieved by the order preparation unit 9, the data prepared by the ERP system and particularly from the data prepared by the CAD system, the central control unit generates a set of production parameters that are required by the production control center 5 or a production data server with related memory to carry out the production of the product in question, and this, in the format suitable for the production control center, and then sends this data to the production control center 5. Similarly to the principle described above, a set of variables can be held ready for the production parameters in the central control unit, which variables are assigned the data prepared by the order preparation unit 9, the ERP system 4 and the CAD system 3. If necessary, dependency and linkage rules can be carried out here as well; they can be stored in the logic module 12. The parameters for machine control are also generated from the data already present. To the extent a CAD system is not used, this can be only the data retrieved by the order preparation unit 9 and the ERP system 4. Usually, however, a CAD system is used.

The control of the data flow with the production department or the production control center can be controlled in various ways after further processing in the ERP system, i.e., the disposition and release of the production order. With manual production, provision can be made for the CAD design drawings prepared in the CAD system to be loaded into the appropriate workstation in the production area. On the other hand, with automatic production, provision can be made for the control program to be supplied with data from the central control unit. The data queries of the production control center are stored in the central control unit in the manner and way described above, and are placed in relation with the data queries already present from the ERP system and the CAD system.

The central control unit 1 therefore assigns, to the set of variables it holds ready, not only the data retrieved by the order preparation unit, but also in part the data that were produced initially by the processing of the product-specific parameters generated by other data processing units, as is obvious in connection with the production control center. For example, a variable, “Production Start”, can be held ready for the production control center in the central control unit 1. The value assigned to this variable can be determined in the ERP system, based on the previously processed ERP parameters that, in turn, were generated using the data input through the order preparation unit. The ERP system can determine the production start particularly as a function of the delivery date requested by the customer and the resources available in the company. The central control unit 1 therefore forms a virtual interface between the ERP system, the CAD system, production control, suppliers, etc.

In addition to the software products of one company, the software of another company can also be connected to this arrangement. For example, if there is a customized product, provision can be made to connect the CAD system of the supplier. The central control unit thus forms the interface between different companies as well.

In the case of customer-specific configuration of the product using the order preparation unit 9, the customer-specific configured product can be displayed advantageously directly at the site. The order preparation unit, as the FIGURE shows, has display means 15, for instance in the form of a display as well as storage means 16, in which a parameterized model of the variant product is stored. Based on the data on the customer-specific product retrieved and input through the input terminal 17, the variables of the parameterized model are assigned and presented to the customer on the spot through the display means. Furthermore, through a customer order simulation, the delivery date and price can even be determined through an online connection to the ERP system of the supplier, preferably using an order simulation device. The relevant data for the customer order simulation can be collected by a representative or a sales employee. This data can be stored in the central control unit.

The automatic data flow control described here also excels particularly in that the parameters and logics for all related software programs can be produced by means of a selection, through configuration masks or using a display tool. These may, in particular, be supplier systems, the CAD or ERP systems of the manufacturer, the supplier or even the customer. Of course, the product that is the subject of the order processing need not be a self-contained product, particularly not as simple a product as a ladder. Orders concerning complex projects, such as the construction of an airport or a residential complex, can be processed advantageously in cases where almost the entire project represents a variant product that has to be configured. This control tool can also be used for Internet portals. Based on a one-time configuration determination, all further required systems are provided with the appropriate specific data.

We claim:

1. A process for control of automatic data flow between data processing units (3, 4, 5, 6, 7, 8, 9) for processing orders related to variant products, comprising at least one ERP system (4) for resource planning for the order processing as well as one order preparation unit (9) for preparation of the order to be processed, wherein a set of product variables is held ready by a central control unit (1) for the appropriate variant product, wherein the order preparation unit (9) assigns the values retrieved for the product variables to the set of product variables so that a set of customer-specific product parameters is produced, and wherein a set of ERP parameters that the ERP system (4) needs for processing the order is automatically generated from the set of specific product parameters in a data format suitable for the ERP system and the same are forwarded to the ERP system (4) by the central control unit (1).

2. Process according to one of the above claims wherein a set of CAD parameters that a CAD system requires to process an order is automatically generated by the central control unit from the customer-specific product parameters previously produced in the data format compatible with the CAD system and forwarded from the central control unit to the CAD system.

3. Process according to one of the above claims wherein the set of variables held ready by the central control unit (1) is determined based on the ERP parameters required by the ERP system (4) and based on the CAD parameters required by the CAD system (3), wherein corresponding and/or dependent ERP parameters and CAD parameters are linked to a variable in the central control unit.

4. Process according to one of the above claims, wherein the data flow between the ERP system (4) and the CAD system (3), on the one hand, and between a production control center, on the other, is controlled by the central control unit (1), wherein a set of production parameters required by the production control center (5) for processing the order is generated by the central control unit (1) from the data retrieved from the order preparation unit (9), the data prepared by the ERP system and/or the data prepared by the CAD system (3), in a format compatible with the production control center (5), and is forwarded automatically to the production control center (5) by the central control unit.

5. Process according to one of the two foregoing claims wherein only the CAD parameters previously generated are stored and/or managed in the central control unit and are re-prepared again at need each time.

6. Device for carrying out the process according to one of the above claims for control of the automatic data flow between data processing units for order processing for a variant product, which device comprises at least one ERP system (4) for resource planning for the order processing, as well as an order preparation unit (9) for preparing the current order, with a central control unit (1) that can be linked with each of the data processing units (3, 4, 9), wherein the central control unit (1) has a memory (10) in which a set of product variables is held ready, wherein the central control unit has data linkage means (11) that links the ERP parameters required by the ERP system (4) to process the current order with the set of product variables, wherein the central control unit has control means (13) that assign the values retrieved by the order preparation unit (1) for the product variables to the set of product variables such that a set of specific product parameters is produced and said central control unit also automatically generates a set of ERP parameters in a data format compatible with the ERP system from the set of specific product parameters and forwards the same to the ERP system (4).

7. Device according to the preceding claim wherein the central control unit (1) can be connected with a CAD system (3) wherein the data linkage means (11) links CAD parameters with the set of product variables, which CAD parameters are required by the CAD system for processing the current order, and wherein the control means (13) of the central control unit (1) automatically generates a specific set of CAD parameters in a data format compatible with the CAD system from the set of specific product parameters previously produced and forwards the same to the CAD system (3).

8. Device according to the preceding claim wherein the data linkage means (11) comprises a logic module (12) that assigns only one common product variable to the corresponding and/or dependent ERP and CAD parameters, stores the current dependency between the ERP and CAD parameters and determines the current ERP or CAD parameters from the corresponding product variables that have been assigned variables, using the related stored dependencies.

9. Device according to one of the preceding claims wherein the central control unit (1) can be connected with a product control center (5), where a set of production control variables is held ready in the memory (10) and the data linkage means (11) is formed for linkage of the production control variables with the CAD parameters of the CAD system (3) and the ERP parameters of the ERP system (4), wherein the central control unit (1) comprises control means (13) that generates a set of production parameters required by the production control center (5) for processing the order in a format compatible with the production control center (5) from the data retrieved from the ERP system (4) and/or from the data held ready in the CAD system (3), and automatically forwards the same to the production control center.

10. Device according to one of the preceding claims, wherein order simulation means (14) are provided that generates an order simulation query to the ERP system (4) based on the set of product parameters and forwards supply data, such as delivery date, price, etc., that the ERP system supplies as a function of the order simulation query, to the order preparation unit.

11. Device according to the preceding claim wherein online connection and communication are provided between the order simulation means (14) and the order preparation unit (9).

12. Device according to one of the preceding claims, wherein the order preparation unit (9) comprises a visualization unit (15) for display of the variant product that comprises, in turn, a storage unit (16) in which a parameterized model of the variant product is stored, wherein the visualization unit (15) fills the variables of the parameterized model with data retrieved for the variant product, and displays the variant product based on variables determined in this manner.

13. Device according to one of the preceding claims wherein only the previously-generated CAD parameters, based on which a CAD drawing can be generated, are stored in the memory (1) of the central control unit (1) instead of a complete CAD drawing.
